(19) United States
(12) Patent Application Publication
(10) Pub. No.: US 2020/0142952 A1
(43) Pub. Date: May 7, 2020

(54) INFORMATION PROCESSING APPARATUS, INFORMATION PROCESSING METHOD, AND STORAGE MEDIUM

(71) Applicant: SHARP KABUSHIKI KAISHA, Sakai City (JP)

(72) Inventors: KENJI AKITOMO, Sakai City (JP); HIROYUKI KAGEYAMA, Sakai City (JP)

(21) Appl. No.: 16/664,348

(22) Filed: Oct. 25, 2019

(30) Foreign Application Priority Data
Nov. 2, 2018 (JP) 2018-207161

(51) Int. Cl. G06F 17/21; G06F 17/22; G06K 9/00

(52) U.S. Cl. CPC G06F 17/214; G06F 17/2247; G06F 17/2211; G06K 9/00422; G06F 17/2264; G06K 9/00409; G06F 17/212

(57) ABSTRACT

The present disclosure provides an information processing apparatus, an information processing method, and a storage medium, capable of improving the display quality after text conversion of a handwritten object, while preserving the layout of the object. The information processing apparatus includes a text converter that character recognizes a handwritten object (A2) and converts the handwritten object (A2) to text information; an object generator that, when the text conversion processing was performed on a handwritten object (A1) that was written by hand right before the handwritten object (A2) and a position of the handwritten object (A2) is within a predetermined range from a position of the handwritten object (A1), determines that a font size corresponding to the handwritten object (A2) is the same size as a font size corresponding to the handwritten object (A1), and generates a text object (T2) corresponding to the handwritten object (A2); and a display processor that causes a display to display the text object (T2).

### INCORPORATION BY REFERENCE

This application is based upon and claims the benefit of priority from the corresponding Japanese Patent Application No. 2018-207161 filed on Nov. 2, 2018, the entire contents of which are incorporated herein by reference.

### BACKGROUND

The present disclosure relates to an information processing apparatus, an information processing method, and a storage medium, in which drawing information can be drawn on (input to) a display with a touch pen.

Conventionally, an electronic board (also referred to as an electronic whiteboard or electronic blackboard) is known as one display device (information processing apparatus) that receives instruction input (a touch) from a user using a touch panel. The electronic board reads the position coordinates of information (an object) written by hand with a touch pen or the like on a touch panel, character-recognizes the object on the basis of the read position coordinate information, converts the object to text, and displays the converted text on a display.

With text conversion on the electronic board, it is important to preserve the layout of the handwritten object. However, when the font size and display position of the converted text are determined on the basis of the size and position of the handwritten object, variation may occur in the font size and display position of the displayed text, and the appearance may consequently deteriorate, resulting in decreased display quality.

The present disclosure provides an information processing apparatus, an information processing method, and a storage medium, capable of improving the display quality after text conversion of a handwritten object, while preserving the layout of the object.

### SUMMARY

An information processing apparatus according to one aspect of the present disclosure is provided with a text converter that performs text conversion processing to character-recognize a first handwritten object written by hand and convert the first handwritten object to text information; a processing determiner that determines whether the text conversion processing was performed on a second handwritten object written by hand right before the first handwritten object; a position determiner that determines whether a position of the first handwritten object is within a predetermined range from a position of the second handwritten object; a size determiner which, when the text conversion processing was performed on the second handwritten object and the position of the first handwritten object is within the predetermined range from the position of the second handwritten object, determines that a font size corresponding to the first handwritten object is the same size as a font size corresponding to the second handwritten object; an object generator that generates a first text object corresponding to the first handwritten object on the basis of the text information converted by the text converter and the font size determined by the size determiner; and a display processor that causes a display to display the first text object generated by the object generator.

An information processing method according to another aspect of the present disclosure includes performing text conversion processing to character-recognize a first handwritten object written by hand and convert the first handwritten object to text information; determining whether the text conversion processing was performed on a second handwritten object written by hand right before the first handwritten object; determining whether a position of the first handwritten object is within a predetermined range from a position of the second handwritten object; determining, when the text conversion processing was performed on the second handwritten object and the position of the first handwritten object is within the predetermined range from the position of the second handwritten object, that a font size corresponding to the first handwritten object is the same size as a font size corresponding to the second handwritten object; generating a first text object corresponding to the first handwritten object on the basis of the text information and the font size; and causing a display to display the first text object.

A storage medium according to yet another aspect of the present disclosure is a non-transitory storage medium on which is stored a program for causing a computer to execute processing including: performing text conversion processing to character-recognize a first handwritten object written by hand and convert the first handwritten object to text information; determining whether the text conversion processing was performed on a second handwritten object written by hand right before the first handwritten object; determining whether a position of the first handwritten object is within a predetermined range from a position of the second handwritten object; determining, when the text conversion processing was performed on the second handwritten object and the position of the first handwritten object is within the predetermined range from the position of the second handwritten object, that a font size corresponding to the first handwritten object is the same size as a font size corresponding to the second handwritten object; generating a first text object corresponding to the first handwritten object on the basis of the text information and the font size; and causing a display to display the first text object.

According to the present disclosure, it is possible to improve the display quality after text conversion of a handwritten object, while preserving the layout of the object.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is block diagram illustrating a configuration of an information processing apparatus according to an embodiment of the present disclosure;

FIG. 2 is a view illustrating an example of a display screen displayed on a display according to the embodiment of the present disclosure;

FIG. 3 is a view illustrating an example of a display screen displayed on the display according to the embodiment of the present disclosure;

FIG. 4 is a view illustrating an example of a display screen displayed on the display according to the embodiment of the present disclosure;

FIG. 5 is a view illustrating an example of a display screen displayed on the display according to the embodiment of the present disclosure;

FIG. 6 is a view illustrating an example of a display screen displayed on the display according to the embodiment of the present disclosure;

FIG. 7 is a flowchart for explaining an example of a sequence of object display processing in the information processing apparatus according to the embodiment of the present disclosure;

FIG. 8 is a flowchart for explaining an example of a sequence of display position determination processing in the information processing apparatus according to the embodiment of the present disclosure;

FIG. 9 is a view illustrating an example of a display screen displayed on the display according to the embodiment of the present disclosure;

FIG. 10 is a view illustrating an example of a display screen displayed on the display according to the embodiment of the present disclosure;

FIG. 11 is a view illustrating an example of a display screen displayed on the display according to the embodiment of the present disclosure;

FIG. 12 is a view illustrating an example of a display screen displayed on the display according to the embodiment of the present disclosure;

FIG. 13 is a view illustrating an example of a display screen displayed on the display according to another embodiment of the present disclosure;

FIG. 14 is a view illustrating an example of a display screen displayed on the display according to yet another embodiment of the present disclosure;

FIG. 15 is a view illustrating an example of a display screen displayed on the display according to still another embodiment of the present disclosure; and

FIG. 16 is a view illustrating an example of a display screen displayed on the display according to the still other embodiment of the present disclosure.

### DETAILED DESCRIPTION

Hereinafter, embodiments of the present disclosure will be described in detail with reference to the accompanying drawings. Note that the following embodiments are only examples embodying the present disclosure, and in no way limit the technical scope of the present disclosure.

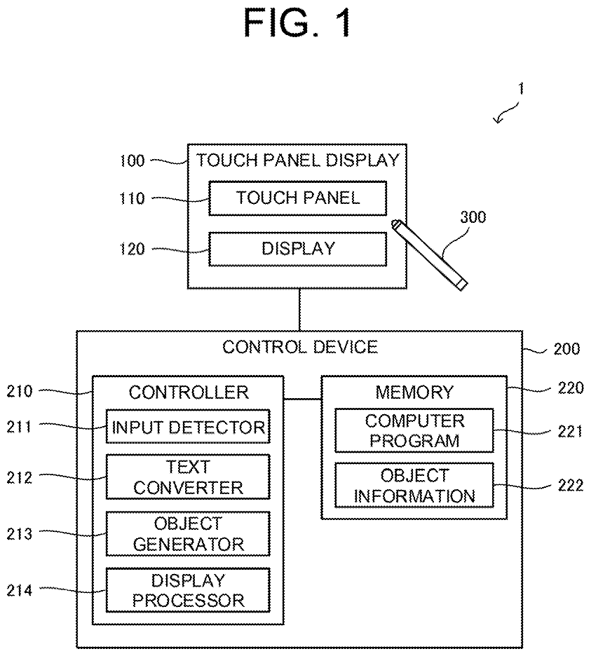

As illustrated in FIG. 1, an information processing apparatus 1 according to one embodiment of the present disclosure includes a touch panel display 100, a control device 200, and a touch pen 300. The control device 200 is a computer that is connected to the touch panel display 100 and controls the touch panel display 100. The touch pen 300 is connected to the control device 200 via a network (wired communication or wireless communication). Note that the touch pen 300 may be omitted.

The touch panel display 100 includes a touch panel 110 and a display 120. The touch panel 110 may be a capacitive touch panel, or a pressure-sensitive or infrared blocking touch panel. That is, the touch panel 110 need simply be a device capable of appropriately receiving operational input from a user, such as touch. The touch panel 110 is provided on the display 120. The display 120 is a liquid crystal display, for example. Note that the display 120 is not limited to a liquid crystal display, and may be a Light Emitting Diode (LED) display, an organic Electro-Luminescence (EL) display, or a projector or the like.

The touch panel display 100 may be a device such as a computer, a tablet terminal, a smartphone, or a car navigation system.

The touch pen 300 is a pen that the user uses to touch (perform input with respect to) the touch panel display 100. If the touch pen 300 is omitted, the user touches (performs input with respect to) the touch panel display 100 with a finger. For example, the user handwrites (draws) an object such as a character or figure using the touch pen 300 or a finger.

As illustrated in FIG. 1, the control device 200 includes memory 220 and a controller 210. The memory 220 stores a computer program 221 that can be executed by the control device 200. The controller 210 is formed by a Central Processing Unit (CPU). When there is an instruction to activate the control device 200 by an operation by the user (for example, when a power button, not illustrated, is pushed), the controller 210 reads the computer program 221 from the memory 220 and executes the computer program 221. As a result, the control device 200 becomes activated.

Also, pen software is installed in the memory 220 as the computer program 221 that can be executed by the control device 200. When the control device 200 is activated and there is an instruction to launch the pen software by an operation by the user, the controller 210 reads the pen software from the memory 220 and executes the pen software. As a result, the pen software launches on the control device 200.

Object information 222 including information regarding a handwritten object such as a character or figure that the user has written by hand on the touch panel display 100, and information regarding a text object that is an object obtained by converting a handwritten character to text format, is stored in the memory 220. The object information 222 includes an image of a handwritten object, an image of a text object, position coordinates of a handwritten object, and the font size of an object (handwritten object or a text object). The object information 222 also includes information regarding the processing content (such as text conversion processing and display processing) executed with respect to a handwritten object. Also, each piece of information is stored in the object information 222 in the order (time series) in which handwritten objects are input by the user.

The controller 210 includes an input detector 211, a text converter 212, an object generator 213, and a display processor 214. The controller 210 controls the display of an image (handwritten image) of a handwritten object such as a character or figure input by hand on the touch panel display 100, and controls the display of an image (input image) input from another image inputting device on the touch panel display 100, for example.

The input detector 211 detects input from the touch pen 300 with respect to the touch panel display 100. More specifically, the input detector 211 detects position coordinates input (specified) by hand on the touch panel 110 with the touch pen 300 or a finger of the user. The input detector 211 stores the detected position coordinates in the object information 222 of the memory 220.

The text converter 212 character-recognizes the handwritten object on the basis of the position coordinates detected by the input detector 211, and performs text conversion processing to convert the handwritten object to text information. For example, when the user handwrites a character on the touch panel display 100 and selects a text conversion command, the text converter 212 character-recognizes the character on the basis of the position coordinates of the handwritten object that was input by hand, and converts the character to text information.

The object generator 213 then generates an object to be displayed on the display 120, on the basis of the position coordinates detected by the input detector 211. For example, the object generator 213 generates a handwritten object on the basis of the position coordinates of the handwritten object that was input by hand. Also, the object generator 213 generates a text object on the basis of the text information converted by the text converter 212. The object generator 213 stores information regarding the image and font size of the generated object in the object information 222 of the memory 220.

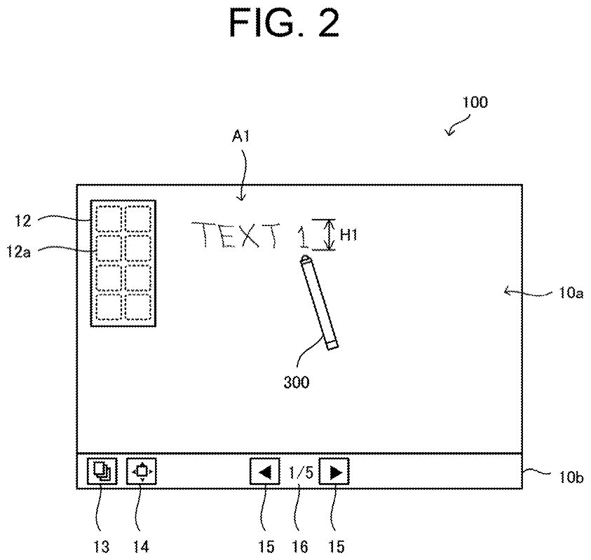

The display processor 214 causes the display 120 to display the image of the object (handwritten object or text object) generated by the object generator 213, and the like. For example, when the pen software is launched in the control device 200 and the user inputs “TEXT 1” by hand using the touch pen 300, the display processor 214 causes the display 120 to display a handwritten object A1 corresponding to the handwriting of the user (refer to FIG. 2).

As illustrated in FIG. 2, the display screen of the display 120 includes a sheet 10a, a toolbar 10b, a menu screen 12, and a plurality of icons 12a included on the menu screen 12. The sheet 10a is arranged in the upper part of the display screen, and the toolbar 10b is arranged in the lower part of the display screen. The sheet 10a corresponds to a region of a board (for example, a whiteboard) that forms the touch panel 110.

The user can draw (input) drawing information such as characters using the touch pen 300 on the sheet 10a (board). FIG. 2 illustrates the drawing information (“TEXT 1”) that the user has drawn using the touch pen 300. When the user draws drawing information on the sheet 10a using the touch pen 300, the input detector 211 detects the input (position coordinates) of the touch pen 300, and the display processor 214 causes the display 120 to display the trajectory of the input on the basis of the position coordinates detected by the input detector 211. Also, the image input from the image input device is displayed on the sheet 10a. In this way, the sheet 10a displayed on the display 120 is configured such that objects such as drawings and images can be arranged on it.

The icons 12a are shortcut icons for executing specific functions of the pen software, and a plurality of the icons 12a are arranged according to the functions. These functions include, for example, “OPEN FILE”, “SAVE FILE”, “PRINT”, “DRAW LINE”, “ERASER”, and “TEXT CONVERSION”, and the like. The user can add a desired function as appropriate.

A plurality of operation buttons for executing functions for operating the display screen are arranged in the toolbar 10b. FIG. 2 illustrates an example of operation buttons 13 to 15. The operation button 13 is an operation button for causing a list of a plurality of the sheets 10a (pages) displayed on the display screen to be displayed as thumbnail images. The operation button 14 is an operation button for causing a menu (not illustrated) of advanced functions to be displayed on the display screen. The operation button 15 is an operation button for advancing or returning (turning the page) the number (sheet number) of the sheet 10a displayed on the display screen. The number of the sheet 10a (page) currently being displayed on the display screen is displayed between two of the operation buttons 15.

Other operation buttons may also be arranged in the toolbar 10b. For example, an operation button for causing a settings screen for the pen software to be displayed, an operation button for putting the pen software in a task tray, or an operation button for closing the pen software, or the like may be arranged in the toolbar 10b.

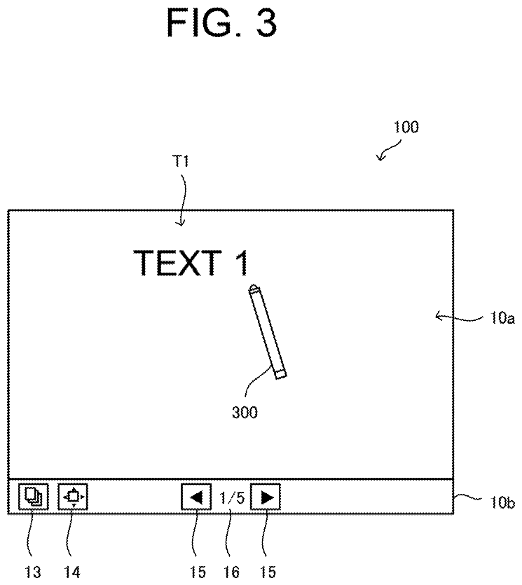

When the user touches (selects) one of the icons 12a on the menu screen 12 using a specifying medium (the pen tip of the touch pen 300 or a fingertip of the user), for example, on the display screen illustrated in FIG. 2, the controller 210 performs processing corresponding to the touch. For example, when the user selects the handwritten object A1 displayed on the display 120 (refer to FIG. 2) in range specification, or the like, and touches a “TEXT CONVERSION” icon 12a (text conversion command) on the menu screen 12, the controller 210 performs processing. First, the text converter 212 character-recognizes the handwritten object A1 on the basis of the position coordinates corresponding to the handwritten object A1 and converts the handwritten object A1 to text information. Next, the object generator 213 generates a text object T1 on the basis of the text information. Finally, the display processor 214 causes the display 120 to display an image of the text object T1, as illustrated in FIG. 3.

Here, the object generator 213 performs processing to determine the character size (font size) of the text object. For example, the object generator 213 determines that the font size of the text object is a font size of the maximum height H1 of the handwritten object A1 illustrated in FIG. 2. FIG. 3 illustrates the text object T1 determined to be of a font size corresponding to the maximum height H1.

Also, for example, when the text conversion processing was performed on the handwritten object input right before, and the position (coordinates) of the handwritten object input this time are within a predetermined range from the position (coordinates) of the handwritten object input right before, the object generator 213 determines that the font size of the text object corresponding to the handwritten object input this time is the same size as the font size determined by the object generator 213 for the text object corresponding to the handwritten object input right before. Note that the “handwritten object input this time” is one example of the first handwritten object of the present disclosure, and the “handwritten object input right before” is one example of the second handwritten object of the present disclosure.

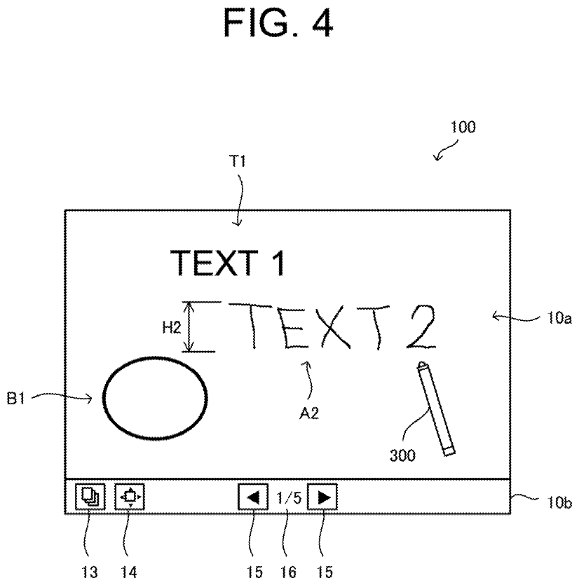

For example, when the text conversion processing is performed as a result of the user inputting the handwritten object A1 (refer to FIG. 2) and selecting the text conversion command, and the text object T1 (refer to FIG. 3) is consequently displayed, the user then inputs a handwritten object A2 (refer to FIG. 4) and selects the text conversion command. In this case, when the text conversion processing was performed on the handwritten object A1 input right before, and the position of the handwritten object A2 input this time is within a predetermined range from the position of the handwritten object A1 (or the text object T1) input right before, the object generator 213 determines that the font size of a text object T2 corresponding to the handwritten object A2 is the same size as the font size determined by the object generator 213 for the text object T1 corresponding to the handwritten object A1.

In contrast, for example, when the user inputs a handwritten object B1 (refer to FIG. 4) after the text object T1 (refer to FIG. 3) is displayed as a result of the user inputting the handwritten object A1 (refer to FIG. 2) and selecting the text conversion command, the object generator 213 generates a handwritten object on the basis of the position coordinates of the handwritten object B1. The display processor 214 causes the display 120 to display an image of the text object T1 and an image of the handwritten object B1 generated by the object generator 213. Next, when the user inputs the handwritten object A2 (refer to FIG. 4) and selects the text conversion command, the object generator 213 performs processing. In this case, the text conversion processing was not performed on the handwritten object B1 input right before the handwritten object A2, so the object generator 213 determines that the font size of the text object T2 is a font size of the maximum height H2 of the handwritten object A2.

Also, even if the text conversion processing was performed on the handwritten object A1 input right before the handwritten object A2, and the position of the handwritten object A2 input this time is not within a predetermined range from the position of the handwritten object A1 input right before, the object generator 213 will determine that the font size of the text object T2 is the font size of the maximum height H2 of the handwritten object A2. Here, the predetermined range is set to a range near the handwritten object input right before. For example, the predetermined range is set to a range around the position (coordinates) of the handwritten object input right before, and according to the height of the font size corresponding to the handwritten object. The predetermined range is not particularly limited, and is set to a range in which a correlation with a plurality of objects is conceivable.

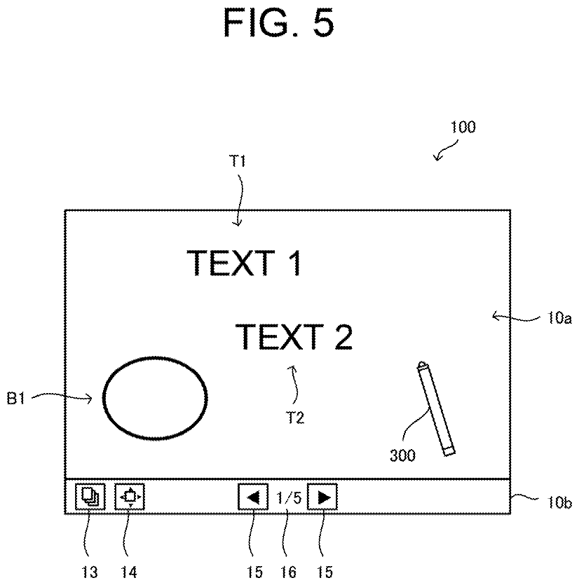

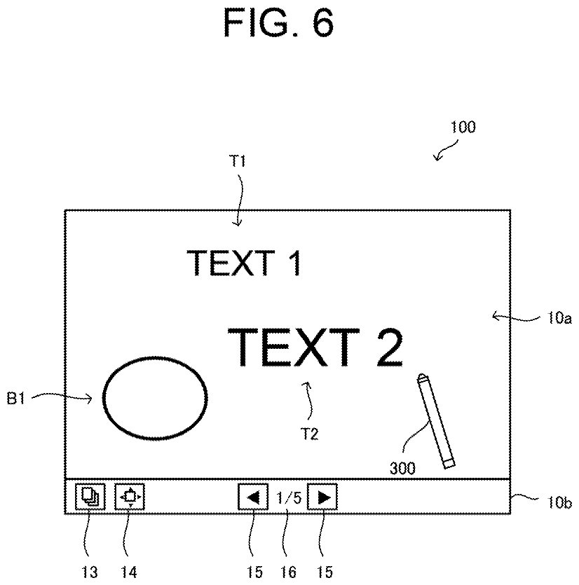

When the font size is determined, the object generator 213 generates the text object T2 on the basis of the text information converted by the text converter 212, and the determined font size. The display processor 214 causes the display 120 to display the text object T2 generated by the object generator 213. If the object generator 213 determines that the font size of the text object T2 is the same size as the font size of the text object T1, the text object T2 will be displayed at the same font size as the text object T1, as illustrated in FIG. 5. On the other hand, if the object generator 213 determines that the font size of the text object T2 is the maximum height H2, the text object T2 will be displayed at a font size corresponding to the size of the handwritten object A2, as illustrated in FIG. 6. The text object T2 is one example of the first text object of the present disclosure, and the text object T1 is one example of the second text object of the present disclosure.

Note that the object generator 213 is one example of the processing determiner, the position determiner, the size determiner, and the object generator of the present disclosure.

Object Display Processing

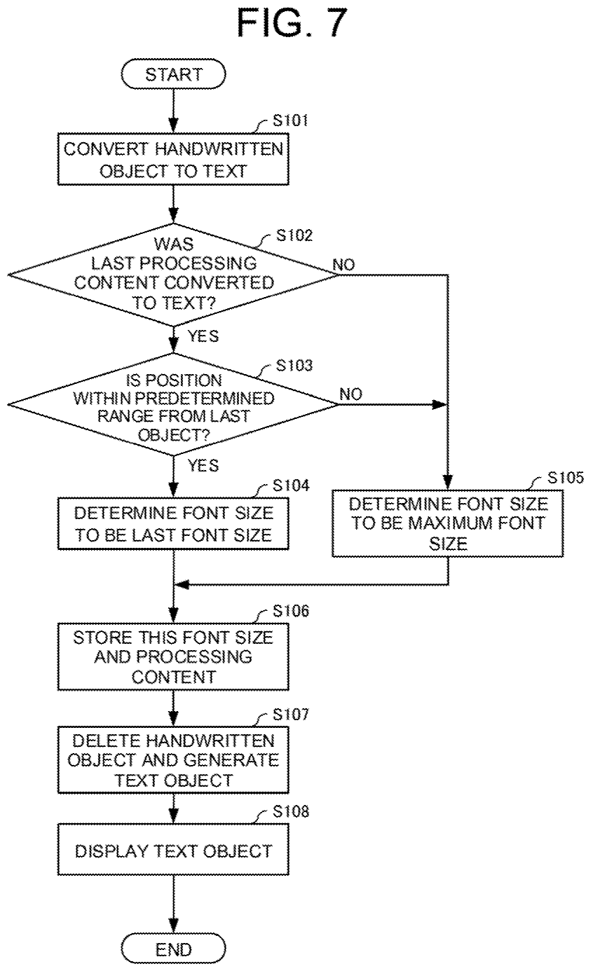

Hereinafter, one example of the sequence of the object display processing executed by the controller 210 of the control device 200 will be described with reference to FIG. 7. The object display processing is one example of the information processing method of the present disclosure. The object display processing starts in response to the user inputting a handwritten object and selecting the “TEXT CONVERSION” icon 12a (text conversion command) on the touch panel display 100. Here, the object display processing will be described according to an example illustrated in FIG. 4 to FIG. 6.

For example, when the user inputs “TEXT 2” by hand using the touch pen 300, the controller 210 (object generator 213) generates the handwritten object A2 and the controller 210 (display processor 214) causes the display 120 to display an image of the handwritten object A2 (refer to FIG. 4). Next, when the user selects “TEXT CONVERSION”, the controller 210 (text converter 212) character-recognizes the handwritten object A2 and converts the handwritten object A2 to text information in step S101.

In step S102, the controller 210 (object generator 213) determines whether the text conversion processing was performed on the handwritten object input right before. If it is determined by the controller 210 that the text conversion processing was performed on the handwritten object input right before, i.e., if text conversion processing was performed on the handwritten object A1 input right before (refer to FIG. 3) (Yes at S102), the processing proceeds on to step S103. On the other hand, if it is determined by the controller 210 that the text conversion processing was not performed on the handwritten object input right before, i.e., if text conversion processing was not performed on the handwritten object B1 input right before (refer to FIG. 4) (No at S102), the processing proceeds on to step S105.

In step S103, the controller 210 (object generator 213) determines whether the position of the handwritten object A2 input this time is within a predetermined range from the position of the handwritten object A1 input right before. If it is determined by the controller 210 that the position of the handwritten object A2 is within the predetermined range from the position of the handwritten object A1 (Yes at step S103), the processing proceeds on to step S104. On the other hand, if it is determined by the controller 210 that the position of the handwritten object A2 is not within the predetermined range from the position of the handwritten object A1 (No at step S103), the processing proceeds on to step S105.

In step S104, the controller 210 (object generator 213) determines that the font size of the text object T2 corresponding to the handwritten object A2 input this time is the same size as the font size determined by the object generator 213 for the text object T1 corresponding to the handwritten object A1 input right before. Note that the controller 210 references the font size of the text object T1 in the object information 222 of the memory 220.

On the other hand, in step S105, the controller 210 (object generator 213) determines that the font size of the text object T2 is the font size of the maximum height H2 (refer to FIG. 4) of the handwritten object A2.

In step S106, the controller 210 stores the processing content for the handwritten object A2 input this time, and information regarding the determined font size, in the object information 222 of the memory 220. For example, the controller 210 stores, in the object information 222, information regarding the “TEXT CONVERSION PROCESSING” as the processing content for the handwritten object A2, and information regarding a font size that is the font size as the font size of the text object T1, as the font size.

In step S107, the controller 210 (object generator 213) deletes the handwritten object A2 of “TEXT 2” that was input by hand, and generates the text object T2 on the basis of the text information of the “TEXT 2” and the font size that was determined.

In step S108, the controller 210 (display processor 214) causes the display 120 to display, on the basis of the position coordinates of the handwritten object A2, an image of the text object T2 generated by the object generator 213 (refer to FIG. 5 and FIG. 6).

As described above, according to the information processing apparatus 1 according to the embodiment of the present disclosure, for example, when the handwritten objects A1 and A2 input by the user are correlated and arranged close together and input in succession, the font sizes of the text objects T1 and T2 obtained by converting the handwritten objects A1 and A2 to text can be made identical and displayed. Accordingly, variation in font size after a handwritten object is converted to text can be suppressed while preserving the layout of the handwritten object, which makes it possible to improve the display quality.

Here, the user may input handwritten characters (handwritten objects A1 and A2), intentionally making the character sizes different. For example, the user may handwrite the handwritten object A2 with a large font size so that it stands out more than the character (handwritten object A1) written by hand right before. In such a case, the information processing apparatus 1 may perform processing. For example, the controller 210 (object generator 213) determines whether a difference between the font size corresponding to the handwritten object A2 input this time and the font size corresponding to the handwritten object A1 (text object T1) input right before exceeds a threshold value. Then, if the difference exceeds the threshold value, the controller 210 (object generator 213) does not match the font size of the text object T2 corresponding to the handwritten object A2 to the font size of the text object T1, but instead determines that the font size of the text object T2 corresponding to the handwritten object A2 is a font size corresponding to the handwritten object A2, i.e., a font size of the maximum height H2 of the handwritten object A2. As a result, text conversion that reflects the intention of the user can be performed. The object generator 213 is one example of the size determiner of the present disclosure.

The information processing apparatus 1 according to the embodiment of the present disclosure may further perform display position determination processing to determine the display position of the text object.

Display Position Determination Processing

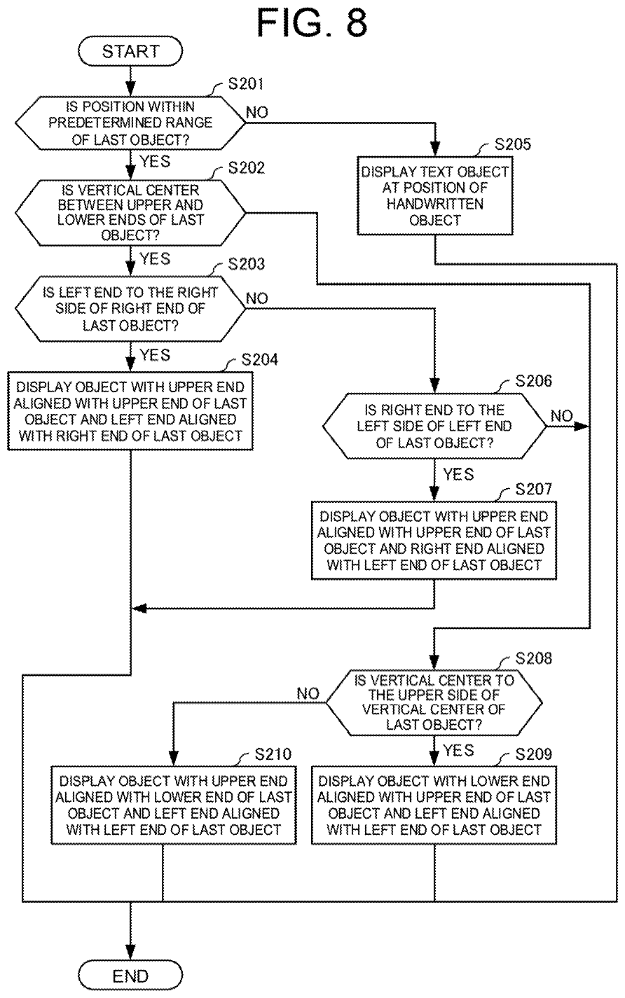

Hereinafter, one example of the sequence of the display position determination processing executed by the controller 210 of the control device 200 will be described with reference to FIG. 8. The display position determination processing is one example of the information processing method of the present disclosure. The display position determination processing starts in response to a text object being generated by the object generator 213.

In step S201, the controller 210 (display processor 214) determines whether the text object T2 corresponding to the handwritten object A2 input this time is within a predetermined range of the text object T1 corresponding to the handwritten object A1 input right before. If the text object T2 is within the predetermined range of the text object T1 (Yes at step S201), the processing proceeds on to step S202, but if the text object T2 is not within the predetermined range of the text object T1 (No at step S201), the processing proceeds on to step S205. In step S205, the controller 210 (display processor 214) causes the text object T2 to be displayed at the position of the handwritten object A2.

In step S202, the controller 210 (display processor 214) determines whether the vertical center of the text object T2 is positioned between the upper end and the lower end of the text object T1. If the center is positioned between the upper end and the lower end of the text object T1 (Yes at step S202), the processing proceeds on to step S203, but if the center is not positioned between the upper end and the lower end of the text object T1 (No at step S202), the processing proceeds on to step S208.

In step S203, the controller 210 (display processor 214) determines whether the left end of the text object T2 is positioned to the right side of the right end of the text object T1. If the left end of the text object T2 is positioned to the right side of the right end of the text object T1 (Yes at step S203), the processing proceeds on to step S204, but if the left end of the text object T2 is not positioned to the right side of the right end of the text object T1 (No at step S203), the processing proceeds on to step S206.

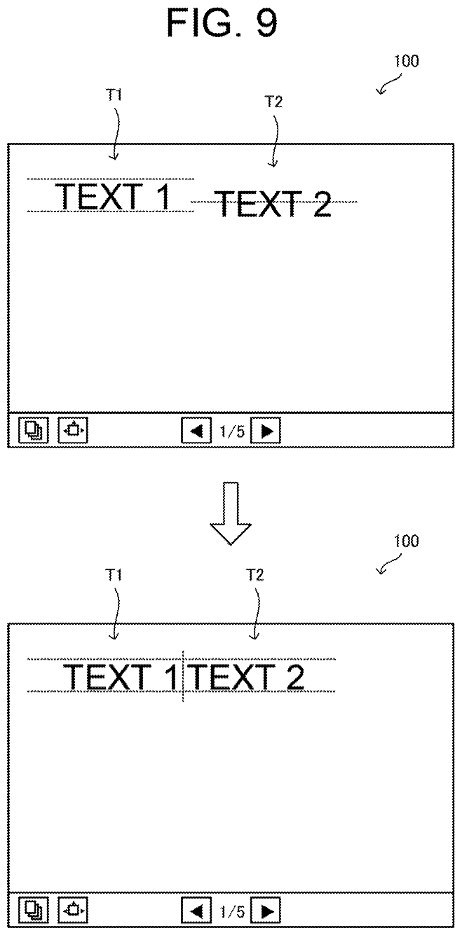

In step S204, the controller 210 (display processor 214) causes the text object T2 to be displayed with the upper end of the text object T2 aligned with the upper end of the text object T1, and the left end of the text object T2 aligned with the right end of the text object T1. FIG. 9 is a view illustrating one example of a display screen corresponding to the processing of step S204. Note that in FIG. 9, the upper and lower horizontal dotted lines of the text object T1 indicate the upper and lower ends, respectively, and the horizontal dotted line in the center of the text object T2 indicates the center. Also, in FIG. 9, the vertical dotted line indicates the right end of the text object T1 and the left end of the text object T2.

In step S206, the controller 210 (display processor 214) determines whether the right end of the text object T2 is positioned to the left side of the left end of the text object T1. If the right end of the text object T2 is positioned to the left side of the left end of the text object T1 (Yes at step S206), the processing proceeds on to step S207, but if the right end of the text object T2 is not positioned to the left side of the left end of the text object T1 (No at step S206), the processing proceeds on to step S208.

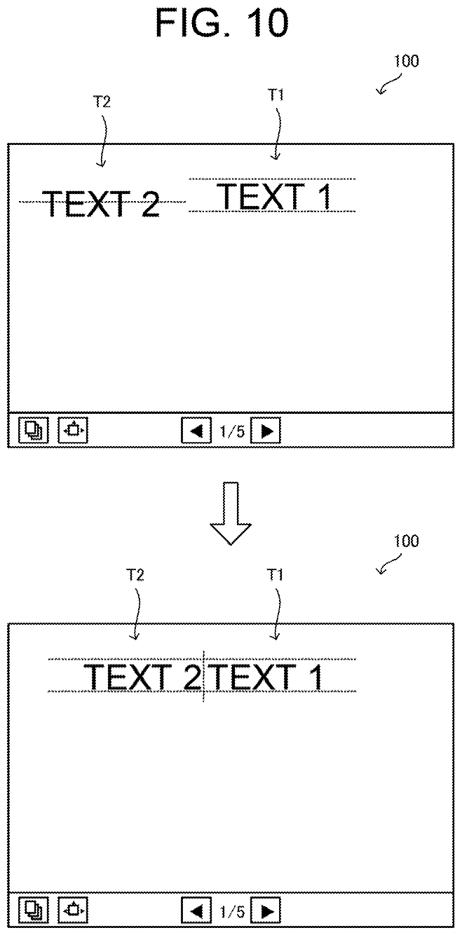

In step S207, the controller 210 (display processor 214) causes the text object T2 to be displayed with the upper end of the text object T2 aligned with the upper end of the text object T1, and the right end of the text object T2 aligned with the left end of the text object T1. FIG. 10 illustrates one example of a display screen corresponding to the processing of step S207.

In step S208, the controller 210 (display processor 214) determines whether the vertical center of the text object T2 is positioned to the upper side of the vertical center of the text object T1. If the vertical center of the text object T2 is positioned to the upper side of the vertical center of the text object T1 (Yes at step S208), the processing proceeds on to step S209, but if the vertical center of the text object T2 is not positioned to the upper side of the vertical center of the text object T1 (No at step S208), the processing proceeds on to step S210.

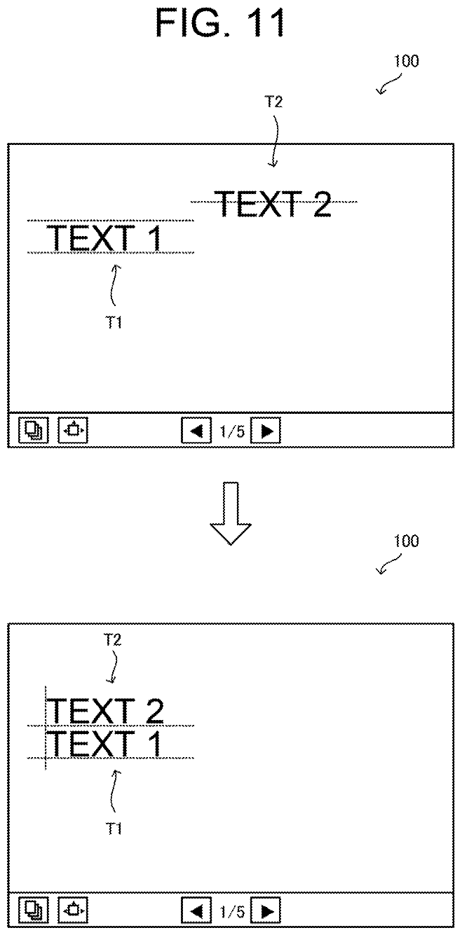

In step S209, the controller 210 (display processor 214) causes the text object T2 to be displayed with the lower end of the text object T2 aligned with the upper end of the text object T1, and the left end of the text object T2 aligned with the left end of the text object T1. FIG. 11 illustrates one example of a display screen corresponding to the processing of step S209.

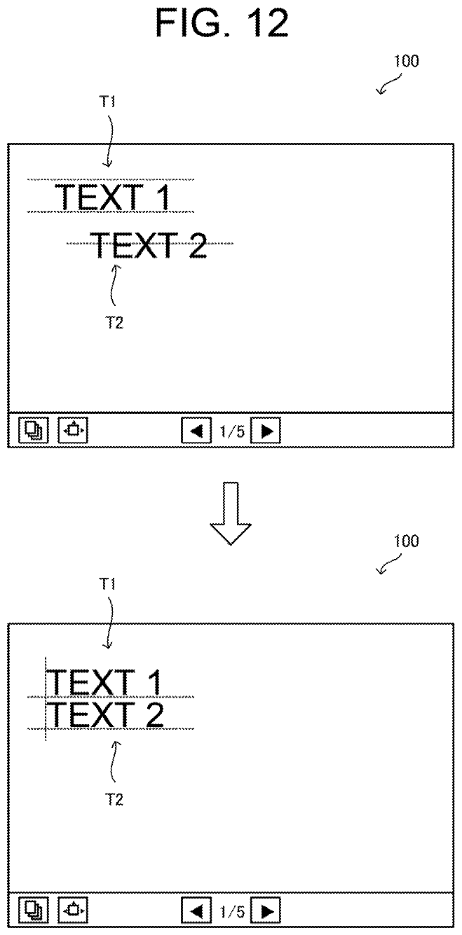

In step S210, the controller 210 (display processor 214) displays the text object T2 with the upper end of the text object T2 aligned with the lower end of the text object T1, and the left end of the text object T2 aligned with the left end of the text object T1. FIG. 12 illustrates one example of a display screen corresponding to the processing of step S210.

According to the foregoing configuration, variation in the positions of the text objects T1 and T2 after text conversion is prevented, thus making the appearance uniform, so the display quality can be improved.

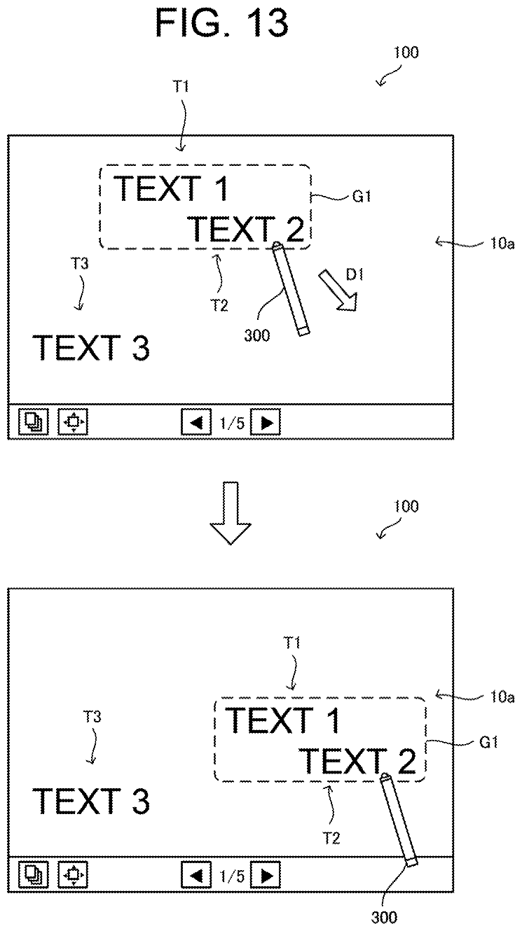

The information processing apparatus 1 according to the embodiment of the present disclosure may further include a configuration for grouping a plurality of text objects. For example, the controller 210 groups the text objects T1 and T2 into the same group when it is determined that the text object T2 is the same size as the font size of the text object T1 and processing to display the text object T2 is performed in the object display processing described above. Also, for example, as illustrated in FIG. 13, when the text objects T1 and T2 are grouped and the user has performed an operation to move one of the objects (text object T2) in the D1 direction on the display screen, the controller 210 causes the other object (text object T1) belonging to a group G1 of the text object T2 to move the same amount and in the same direction as the text object T2. Note that a text object T3 is not grouped in the same group G1 because the text object T3 is not within the predetermined range of the text objects T1 and T2. The controller 210 is one example of a grouper of the present disclosure.

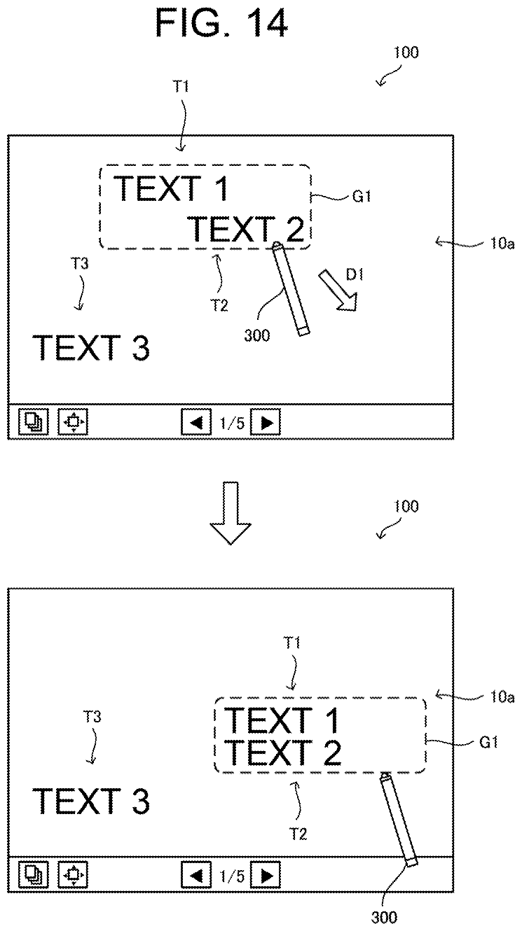

Also, the controller 210 may further perform processing to adjust the display position of a plurality of text objects belonging to the same group, when a grouped text object is moved. For example, as illustrated in FIG. 14, when the text objects T1 and T2 are grouped and the user has performed an operation to move the text object T2 in the D1 direction on the display screen, the controller 210 (display processor 214) performs processing that causes the text object T1 belonging to the group G1 of the text object T2 to move the same amount and in the same direction as the text object T2, and aligns the left ends of the text objects T1 and T2,

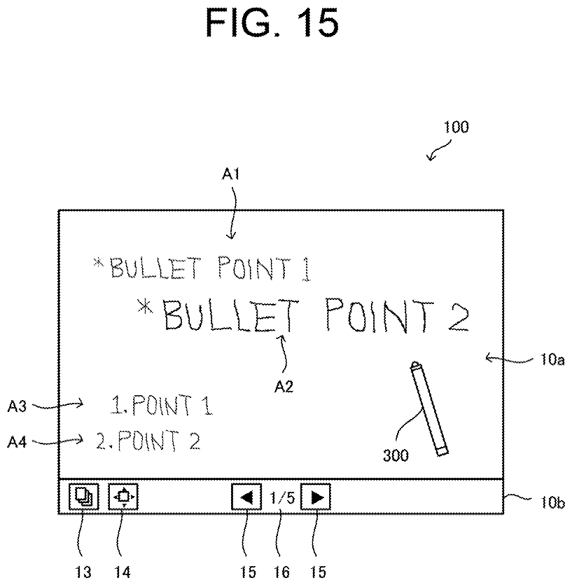

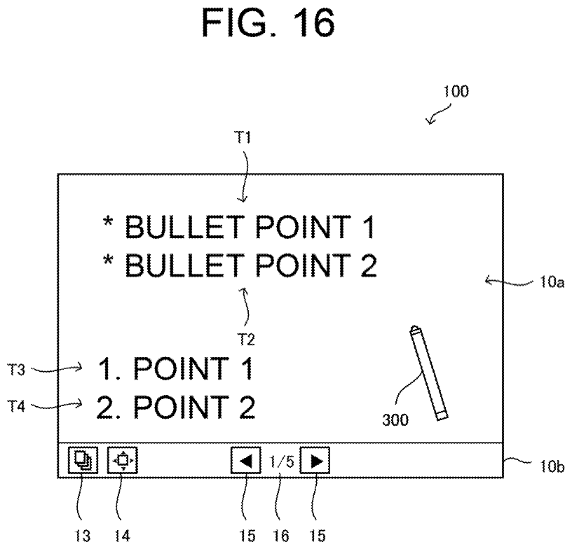

Also, the information processing apparatus 1 according to the embodiment of the present disclosure may determine the font size and display position of a text object on the basis of the content of the first character of the text object. For example, when the first characters of text objects are the same symbol as a result of performing the text conversion processing on the handwritten objects A1 and A2 (refer to FIG. 15), the controller 210 determines that the font sizes of the text objects T1 and T2 corresponding to the handwritten objects A1 and A2 are the same size and displays the text objects T1 and T2 with the display positions aligned, as illustrated in FIG. 16. Similar processing is also performed when the first characters are related, as illustrated by handwritten objects A3 and A4.

Note that the information processing apparatus 1 according to the present disclosure can also be configured by freely combining the embodiments illustrated above, or modifying or partially omitting as appropriate, the embodiments, within the scope of the invention described in the claims.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing apparatus comprising:
a text converter that performs text conversion processing to character recognize a first handwritten object written by hand and convert the first handwritten object to text information;
a processing determiner that determines whether the text conversion processing was performed on a second handwritten object written by hand right before the first handwritten object;
a position determiner that determines whether a position of the first handwritten object is within a predetermined range from a position of the second handwritten object;
a size determiner which, when the text conversion processing was performed on the second handwritten object and the position of the first handwritten object is within the predetermined range from the position of the second handwritten object, determines that a font size corresponding to the first handwritten object is the same size as a font size corresponding to the second handwritten object;
an object generator that generates a first text object corresponding to the first handwritten object on the basis of the text information converted by the text converter and the font size determined by the size determiner; and
a display processor that causes a display to display the first text object generated by the object generator.

2. The information processing apparatus according to claim 1, wherein when the text conversion processing was not performed on the second handwritten object, or when the position of the first handwritten object is not within the predetermined range from the position of the second handwritten object, the object generator determines that the font size corresponding to the first handwritten object is a font size of a maximum height of the first handwritten object.

3. The information processing apparatus according to claim 1, further comprising:
a size determiner that determines whether a difference between the font size corresponding to the first handwritten object and the font size corresponding to the second handwritten object exceeds a threshold value,
wherein if the difference exceeds the threshold value, the object generator determines that the font size corresponding to the first handwritten object is the font size of a maximum height of the first handwritten object.

4. The information processing apparatus according to claim 1, wherein the display processor causes a display to display the first text object aligned with a position of a second text object corresponding to the second handwritten object.

5. The information processing apparatus according to claim 4, further comprising:
a grouper that groups the first text object and the second text object,
wherein when one of the first text object and the second text object grouped by the grouper is moved a first moving amount in a first direction, the display processor causes the other to be moved the first moving amount in the first direction.

6. An information processing method comprising:
performing text conversion processing to character-recognize a first handwritten object written by hand and convert the first handwritten object to text information;
determining whether the text conversion processing was performed on a second handwritten object written by hand right before the first handwritten object;
determining whether a position of the first handwritten object is within a predetermined range from a position of the second handwritten object;
determining, when the text conversion processing was performed on the second handwritten object and the position of the first handwritten object is within the predetermined range from the position of the second handwritten object, that a font size corresponding to the first handwritten object is the same size as a font size corresponding to the second handwritten object;
generating a first text object corresponding to the first handwritten object on the basis of the text information and the font size; and
causing a display to display the first text object.

7. A non-transitory storage medium on which is stored a program for causing a computer to execute processing including:
performing text conversion processing to character-recognize a first handwritten object written by hand and convert the first handwritten object to text information;
determining whether the text conversion processing was performed on a second handwritten object written by hand right before the first handwritten object;
determining whether a position of the first handwritten object is within a predetermined range from a position of the second handwritten object;
determining, when the text conversion processing was performed on the second handwritten object and the position of the first handwritten object is within the predetermined range from the position of the second handwritten object, that a font size corresponding to the first handwritten object is the same size as a font size corresponding to the second handwritten object;
generating a first text object corresponding to the first handwritten object on the basis of the text information and the font size; and
causing a display to display the first text object.
